(19) United States
(12) Patent Application Publication
(10) Pub. No.: US 2003/0145494 A1
(43) Pub. Date: Aug. 7, 2003

(54) Lightening device for a shoe

(76) Inventor: Tai Ping Hsu, Taipei (TW)

Correspondence Address: BACON & THOMAS, PLLC, 625 SLATERS LANE, FOURTH FLOOR, ALEXANDRIA, VA, 22314

(21) Appl. No.: 10/062,527

(22) Filed: Feb. 5, 2002

(51) Int. Cl. F21V 21/08; A43B 23/00

(52) U.S. Cl. 36/137; 362/103

(57) ABSTRACT

A lightening device for a shoe having a receiving portion provided in the heel of the shoe body, the receiving portion is covered with an openable lid, a driving assembly is received in the receiving portion, a plurality of electro-luminescent pieces connecting with the driving assembly are provided in a transparent instep of the shoe. Thereby, the battery in the driving assembly can make the electro-luminescent pieces always lighten; a control circuit controls the effect of steady lightening or flashing of the electro-luminescent pieces. Particularly, when the battery is exhausted, a user can lift the lid to expose the driving assembly to change for a new battery, after that, the lightening device can be activated again to lighten when the lid is closed.

### BACKGROUND OF THE INVENTION

1. Field of the Invention

The present invention is related to a lightening device for a shoe, and especially related to a lightening device of which the battery can be taken out of the shoe when it is exhausted, to change for a new battery after lifting a lid to expose a driving assembly, the lightening device can be activated again to lighten when the lid is closed.

2. Description of the Prior Art

Conventional lightening devices for shoes in the markets mainly have LED's and batteries for generating light sources sealed in the heels of the shoes, so that the heels of the shoes can have the function of generating light. The structure of such an LED is not easy to be connected with other soft parts of a shoe, and can only be embedded in the heel of the shoe which is solider structurally, hence the lightening portion is limited to the area of the heel, and thereby directly makes a hinder against variation forms of shoes.

Besides, the battery in a conventional lightening device for a shoe is directly sealed in the heel of the shoe; when the battery is exhausted, the user is unable to change it by himself, thereby, the function of generating light is limited by the power of the battery. Particularly when in avoiding wasting of the power of the battery of the conventional lightening device, a pressing contact switch is provided to control connection between the battery and the LED; so that when the pressing contact switch is turned on by stepping the shoe on the ground, an effect of lightening can be generated. However, this not only limits the activating function or the lightening effect of shoe to actions of walking or exercising of the user, but also makes the lightening device invalid when the switch which is subjected to damaging is damaged. The life of use of the lightening device can thus be reduced.

### SUMMARY OF THE INVENTION

In view of the above statement, the lightening device for a shoe of the present invention is provided in the heel of the shoe with a receiving portion covered with an openable lid, a driving assembly is received in the receiving portion, a plurality of electro-luminescent pieces connected with the driving assembly are provided in a transparent instep of the shoe. Thereby, the battery in the driving assembly can make the electro-luminescent pieces always lighten, the surface of the shoe hence lightens; a control circuit controls the effect of steady lightening or flashing of the electro-luminescent pieces. Particularly, when the battery is exhausted, a user can lift the lid to expose the driving assembly to change for a new battery, after that, the lightening device can be activated again to lighten when the lid is closed. And this is the main object of the present invention.

Another object of the present invention is to make combination of the flexible electro-luminescent pieces with other softer areas of the shoe to increase variations of allocation as well as designing of the electro-luminescent pieces.

The present invention will be apparent from the detailed description of an embodiment thereof in reference to the accompanying drawings.

### BRIEF DESCRIPTION OF THE DRAWINGS

FIG. 1 is a perspective view showing the appearance of an embodiment of the present invention;

FIG. 2 is an analytic view showing the structure of the present invention;

FIG. 3 is a perspective view showing the appearance of another embodiment of the present invention.

### DETAILED DESCRIPTION OF THE INVENTION

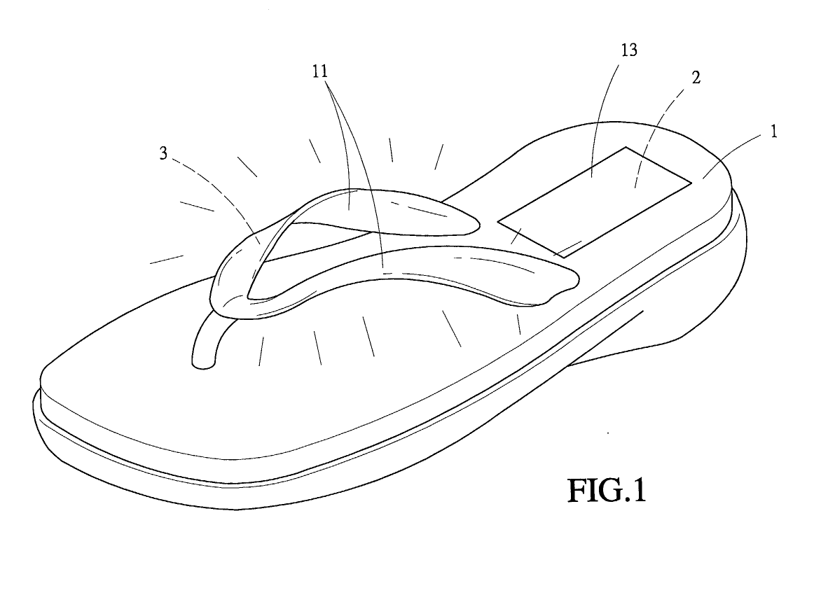

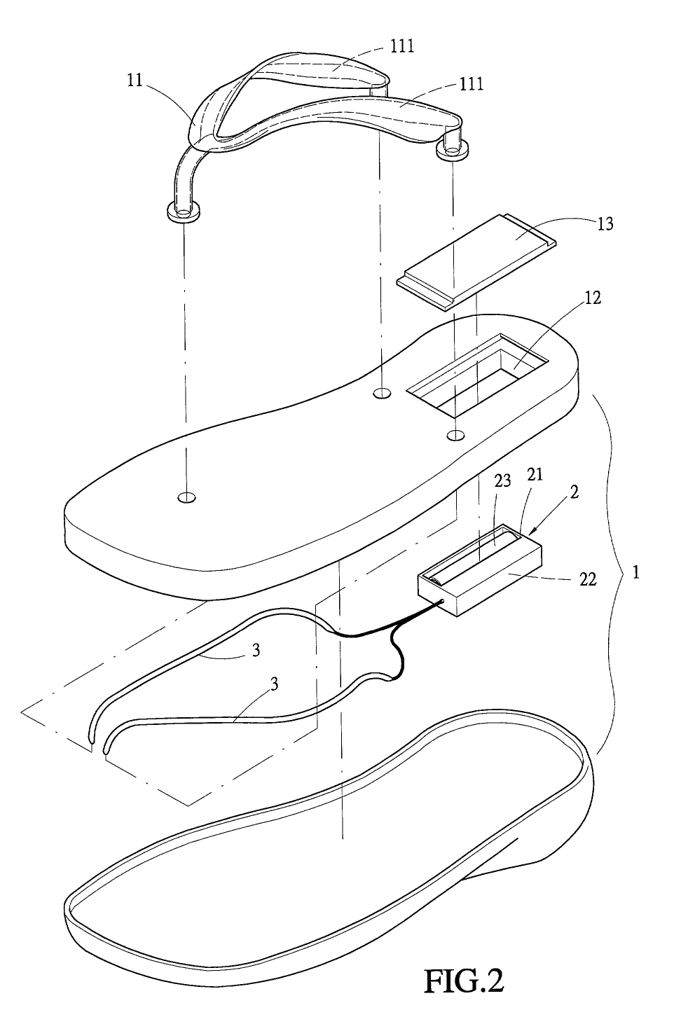

Referring to FIG. 1 and 2, the structure of the lightening device for a shoe of the present invention is depicted in the drawings, wherein, a shoe body 1 is the main body for loading and application of the lightening device, the shoe body 1 has a transparent instep 11. In the embodiment shown, the instep 11 is in the form of a belt with a plurality of receiving spaces 111 therein. And the heel of the shoe body 1 has a receiving portion 12, an openable lid 13 is provided to cover the receiving portion 12. A plurality of electro-luminescent pieces 3 are provided in the receiving spaces 111 in meeting the form of the shoe body 1 designed, and are connected with the instep 11 to be protected by the latter. The electro-luminescent pieces 3 can surely be provided at some area exclusive of the instep 11 of the shoe body 1.

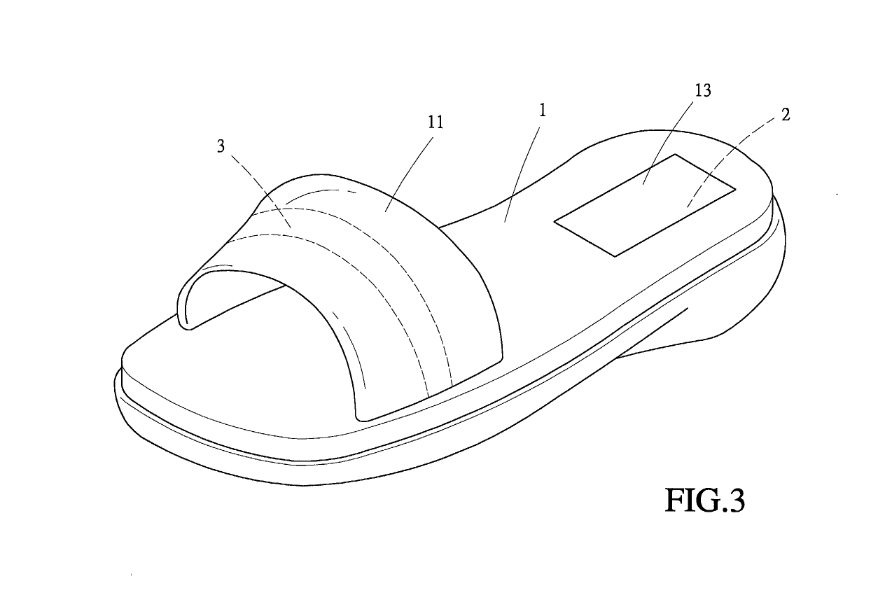

And more, a driving assembly 2 is received in the receiving portion 12 of the shoe body 1; the electro-luminescent pieces 3 are connected with the driving assembly 2 to generate a light source. Wherein, the driving assembly 2 is comprised of a battery seat 21, a control circuit 22 and a battery 23; the control circuit 22 is sealed in the battery seat 21 on one side of the latter to connect with the battery 23 therein. Thereby, the entire lightening device can be definitely firmly combined with the shoe body 1, and the electro-luminescent pieces 3 can be lightened for long by the battery 23 of the driving assembly 2, and the entire instep 11 can be lightened, the control circuit 22 controls the electro-luminescent pieces 3 to give the effect of steady lightening or flashing. Particularly, when the battery 23 is exhausted, a user can lift the lid 13 to expose the driving assembly 2 to change for a new battery, after that, the lightening device can be activated again to lighten when the lid 13 is closed. And more, the present invention uses the electro-luminescent pieces 3 as the main light emitting elements, they can be connected with other soft parts of the shoe; and as shown in FIG. 3, the instep 11 can also be designed as a sheet, thereby, the entire lightening device can have increased variations in designing allocation of the lightening device in relation to the shoe body 1.

In the lightening device for a shoe of the present invention, by providing a receiving portion in the heel of the shoe body, and a plurality of electro-luminescent pieces connecting with the driving assembly are provided in the transparent instep, the battery in the driving assembly makes lightening of the electro-luminescent pieces for long, and the control circuit controls the electro-luminescent pieces to give the effect of steady lightening or flashing. Particularly, when the battery is exhausted, a user can lift the lid to expose the driving assembly to change for a new battery, after that, the lightening device can be activated again to lighten when the lid is closed. Thereby, a better lightening device for a shoe is provided.

Having thus described the practicable and improved invention, the structure has never existed in the markets.

What I claim as new and desire to be secured by Letters Patent of the United States are:

1. A lightening device for a shoe, comprising:
a shoe body which is the main body for loading and application of said lightening device, said shoe body has a transparent instep, and has a receiving portion, an openable lid is provided to cover said receiving portion;
a plurality of electro-luminescent pieces provided in said instep in meeting the form of said shoe body designed;
and a driving assembly received in said receiving portion of said shoe body, and connected with electric lines of said electro-luminescent pieces, wherein, said driving assembly is comprised of a battery seat, a control circuit and a battery to drive said electro-luminescent pieces for generating a light source, said control circuit is sealed in said battery seat on one side of the latter to connect with said battery in said battery seat;
said lightening device thereby is definitely firmly combined with said shoe body, and said electro-luminescent pieces are lightened for long by said battery of said driving assembly, and the entire of said instep is lightened, said control circuit controls said electro-luminescent pieces to give the effect of steady lightening or flashing; particularly, when said battery is exhausted, said lid is adapted to lifting to expose said driving assembly to change for a new battery, after that, said lightening device is activated again to lighten when said lid is closed.

2. A lightening device for a shoe as stated in claim 1, wherein, said shoe body is provided with a plurality of hollow receiving spaces for said electro-luminescent pieces to allow said electro-luminescent pieces to connect with said instep to be protected by said instep.

3. A lightening device for a shoe as stated in claim 1, wherein, said instep is in the form of a belt.

4. A lightening device for a shoe as stated in claim 1, wherein, said instep is in the form of an enveloping sheet.

5. A lightening device for a shoe as stated in claim 1, wherein, said electro-luminescent pieces are provided at an area exclusive of said instep of said shoe body.

6. A lightening device for a shoe as stated in claim 1, wherein, said receiving portion is provided in said heel of said shoe body.
